(19) United States
(12) Patent Application Publication
(10) Pub. No.: US 2016/0020541 A1
(43) Pub. Date: Jan. 21, 2016

(54) TERMINAL

(71) Applicant: YAZAKI CORPORATION, Tokyo (JP)

(72) Inventor: Naoki TAKAMURA, Shizuoka (JP)

(21) Appl. No.: 14/799,645

(22) Filed: Jul. 15, 2015

(30) Foreign Application Priority Data
Jul. 17, 2014 (JP) 2014-146718

(51) Int. Cl. H01R 13/24; H01R 4/16

(52) U.S. Cl. CPC H01R 13/2407; H01R 4/16

(57) ABSTRACT

A terminal (1) includes a tubular portion (3), a spring portion (4), and a protrusion (6). The tubular portion (3) includes a terminal insertion chamber (3a). The spring portion (4) protrudes in the tubular portion (3) and is in contact with a rod portion (51) of a mating terminal (50) inserted into the terminal insertion chamber (3a), while being elastically deformed outward. The protrusion (6) is provided in the tubular portion (3) and protrudes in an elastic deformation region of the spring portion (4). The spring portion (4) is abutted against the protrusion (6) and is in contact with the rod portion (51) of the mating terminal (50) at a portion corresponding to the protrusion (6).

### CROSS REFERENCE TO RELATED APPLICATIONS

This application claims the priority of Japanese Patent Application No. 2014-146718, filed on Jul. 17, 2014, the entire content of which are incorporated herein by reference.

### BACKGROUND

1. Technical Field

The present invention relates to a terminal adapted to be in electrical contact with a mating terminal.

2. Related Art

As a first conventional example of this type of terminal, a terminal shown in FIG. 6 has been proposed (see JP 2013-137949 A). This terminal 100 has a tubular portion 101 through which a rod portion 111 of a mating terminal 110 is inserted, and a plate-shaped spring portion 102 is arranged in the tubular portion 101. The spring portion 102 is extended from the tubular portion 101 and has a cantilever support structure in which its front end is a free end. The spring portion 102 has, on its front end side, an indented portion 102a protruding upward. The tubular portion 101 has a protrusion 101a on the bottom surface portion. The protrusion 101a is arranged in an elastic deformation region of the spring portion 102.

When the rod portion 111 of the mating terminal 110 is inserted into the tubular portion 101, the spring portion 102 is bent and deformed to allow insertion of the rod portion 111. The spring portion 102 is abutted against the protrusion 101a during the bending deformation of the spring portion 102 and then bent and deformed with the protrusion 101a as a spring fulcrum point. At an insertion completion position where the insertion of the mating terminal 110 is completed, the indented portion 102a of the spring portion 102 is in contact with the rod portion 111 of the mating terminal 110.

As a second conventional example, a terminal shown in FIG. 7 has been proposed (see JP H06-13119 A). This terminal 120 has a tubular portion 121 through which a rod portion (not shown) of a mating terminal is inserted, and a plurality of spring portions 122 is arranged in the tubular portion 121. The spring portions 122 are both-end supported and are formed by punching and bending the tubular portion 121.

When the rod portion (not shown) of the mating terminal is inserted into the tubular portion 121, the center of each of the spring portions 122 is bent and deformed outward to allow insertion of the rod portion. At an insertion completion position of the mating terminal, the innermost portion of each of the spring portions 122 is in contact with the rod portion of the mating terminal.

### SUMMARY

However, in both the first and second conventional examples, since the spring portion is in contact with the rod portion of the mating terminal by the return force of the spring portion, which acts as a contact load, at the insertion completion position of the mating terminal, the spring portion can be elastically displaced in a direction in which the spring portion is spaced apart from the rod portion of the mating terminal. Thus, the spring portion may be spaced apart from the rod portion of the mating terminal by an external force due to vibration or the like to cause instability of contact with the mating terminal.

It is desirable to provide a terminal which can prevent instability of contact between the terminal and a mating terminal due to an external force such as vibration.

A terminal according to one aspect of the present invention includes a tubular portion including a terminal insertion chamber, a spring portion which protrudes in the tubular portion and is in contact with a rod portion of a mating terminal inserted into the terminal insertion chamber, while being elastically deformed outward, and a protrusion which is provided in the tubular portion and protrudes in an elastic deformation region of the spring portion. The spring portion is abutted against the protrusion and is in contact with the rod portion of the mating terminal at a portion corresponding to the protrusion.

The spring portion may be a cantilever support extending from the tubular portion, and a free end side of a front end of the spring portion may be in contact with the rod portion of the mating terminal by the elastic return force. The tubular portion may have a cylindrical shape, and a plurality of the spring portions may be arranged at equal intervals in a circumferential direction of the tubular portion.

According to one aspect of the present invention, in a spring portion a portion corresponding to a protrusion may not be elastically displaced toward the protrusion. Accordingly, even if an external force due to vibration or the like is applied to the spring portion, the spring portion can reliably maintain contact with the mating portion, thus preventing instability of the contact.

### BRIEF DESCRIPTION OF DRAWINGS

FIG. 1 is an overall perspective view of a female terminal and a mating terminal in accordance with one embodiment of the present invention;

FIG. 2 is a front view of the female terminal in accordance with this embodiment;

FIG. 3 is an A-A line cross-sectional view of FIG. 2 in accordance with this embodiment;

FIG. 4 is a cross-sectional view of the female terminal through which a male terminal is inserted in accordance with this embodiment;

FIG. 5A is a cross-sectional view of a relevant portion of a tubular portion through which the male terminal is not inserted in accordance with this embodiment;

FIG. 5B is a cross-sectional view of the relevant portion of the tubular portion through which the male terminal is inserted in accordance with this embodiment;

FIG. 6 is a cross-sectional view of a terminal of a first conventional example; and

FIG. 7 is a side view of a terminal of a second conventional example.

### DETAILED DESCRIPTION

Hereinafter, one embodiment of the present invention will be described based on the drawings.

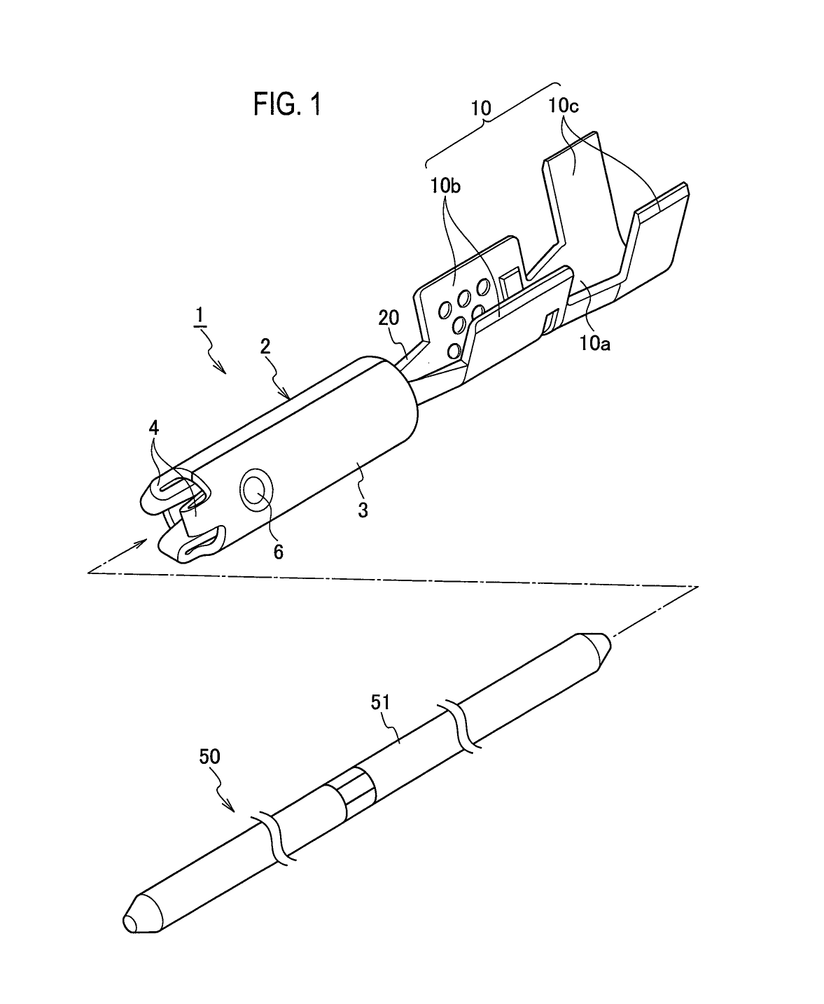

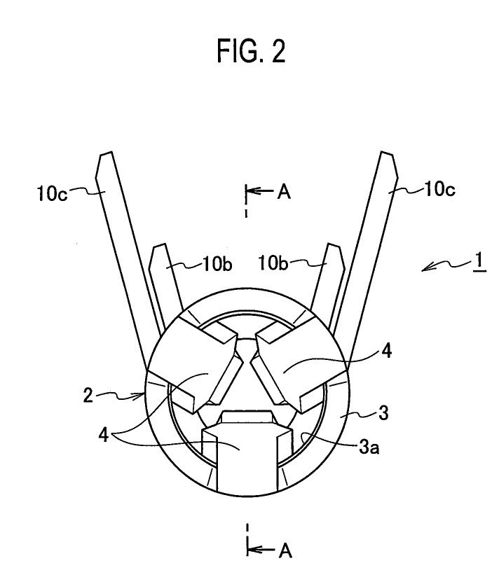

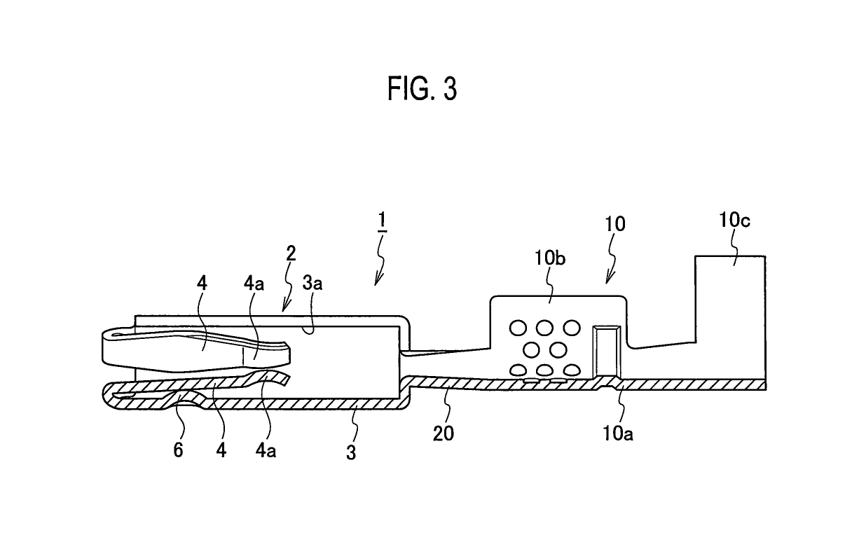

FIGS. 1 to 5B show one embodiment of the present invention. As shown in FIGS. 1 to 3, a female terminal (a terminal) is formed by folding an electroconductive plate material (for example, a copper alloy material). A female terminal 1 includes a mating terminal connecting portion 2, a wire connecting portion 10, and a coupling portion 20 for coupling the mating terminal connecting portion 2 and the wire connecting portion 10.

The mating terminal connecting portion 2 includes a tubular portion 3 and three spring portions 4 formed integrally with the tubular portion 3.

The tubular portion 3 has a cylindrical shape and is opened at its front end from which a male terminal 50, which is a mating terminal, is inserted. The tubular portion 3 has a terminal insertion chamber 3a into which the male terminal 50 is inserted. The tubular portion 3 may not be elastically deformed in a radially expanding direction (outward).

The three spring portions 4 extend from the front end of the tubular portion 3 and are formed by being folded inward of the tubular portion 3. The three spring portions 4 are arranged at equal intervals in a circumferential direction of the tubular portion 3. Each of the spring portions 4 extends in an insertion direction of the male terminal 50 and inclines in a direction in which an interval between the spring portions 4 is gradually reduced toward the front ends of the spring portions 4. On the front end side, each of the spring portions 4 has an indented portion 4a, formed by bending each of the spring portions 4 and protruding in a direction toward each other. A protrusion 6 is provided in an elastic deformation region of each of the spring portions 4. Each of the protrusions 6 is provided by punching the tubular portion 3. Since each of the protrusions 6 is formed integrally with the tubular portion 3, the protrusion 6 may not be displaced outward. Each of the spring portions 4 is abutted against the protrusion 6 by bending deformation, and in the bending deformation after the abutment, the front end side ranging from a spring fulcrum point of the spring portion 4 is bent and deformed with the protrusion 6 as a spring fulcrum point. In such a state that each of the spring portions 4 is abutted against the protrusion 6, a space dimension of the three spring portions 4 at the position of the protrusion 6 is set so that a rod portion 51 of the male terminal 50 mates with the spring portions 4.

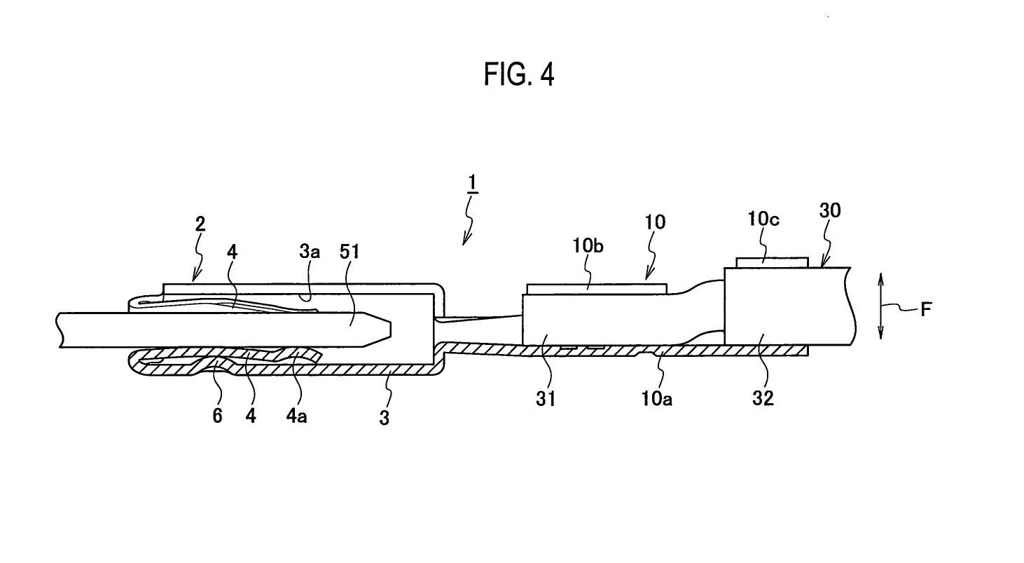

The wire connecting portion 10 has a conductor caulking portion 10b extending on both sides of the wire connecting portion 10 relative to a base 10a and a wire caulking portion 10c extending on both sides of the wire connecting portion 10 relative to the base 10a. The conductor caulking portion 10b caulks a conductor 31 (shown in FIG. 4) with an exposed wire (not shown) to cover the conductor 31 from outside. The wire caulking portion 10c caulks a wire 30 (shown in FIG. 4) surrounded by an insulation jacket 32 to cover the wire 30 from outside.

The male terminal 50 which is a mating terminal has the rod portion 51 having a circumferential surface. The rod portion 51 may be solid or hollow (cylindrical).

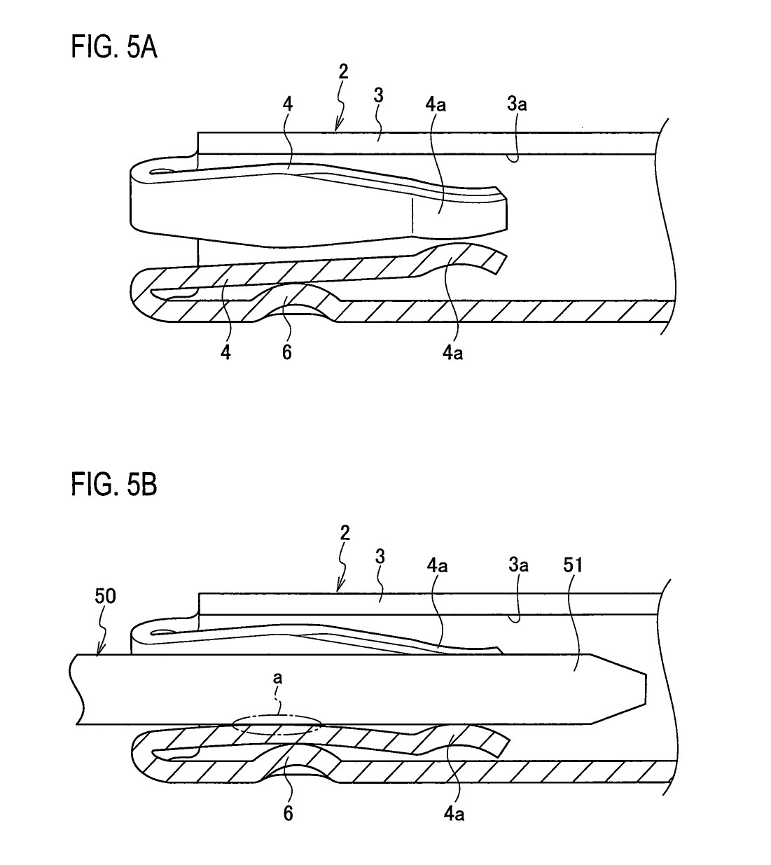

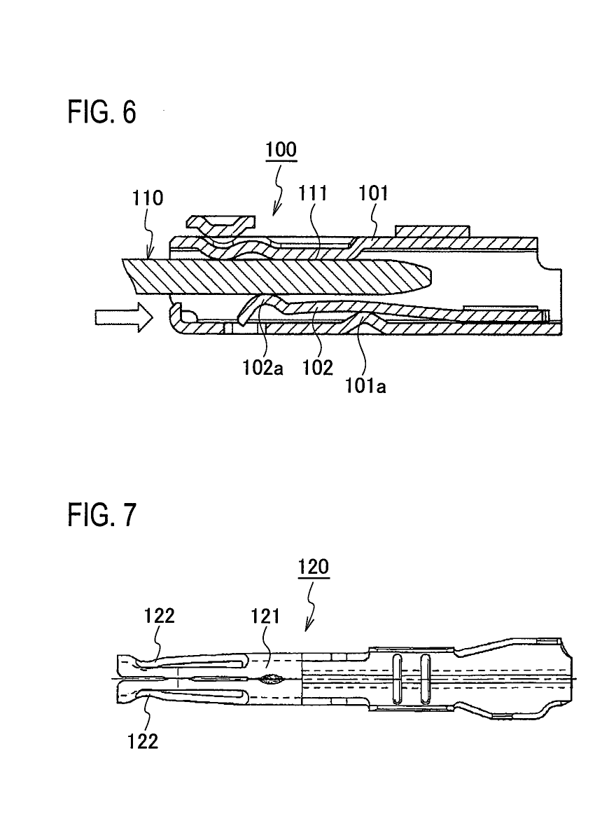

In the above constitution, the rod portion 51 of the male terminal 50 is inserted into the tubular portion 3 of the female terminal 1. At this time, the front end of the rod portion 51 enters among the three spring portions 4 and is abutted against each of the spring portions 4. In this state, if the rod portion 51 enters deeper in the tubular portion 3, the three spring portions 4 are bent and deformed outward to expand the space between them and, thus, to allow insertion of the rod portion 51. When the rod portion 51 has been inserted to an insertion completion position, the male terminal 50 is fitted into the female terminal 1. At the insertion completion position, as shown in FIGS. 4 and 5B, each of the spring portions 4 and the rod portion 51 are in contact with each other at the position of the protrusion 6 (an a region of FIG. 5B) of each of the spring portions 4 and the position of the indented portion 4a on the front end side of each of the spring portions 4. At the position of the protrusion 6 of each of the spring portions 4, the rod portion 51 of the male terminal 50 is fitted into the tubular portion 3 at the positions of the three protrusions 6 through the spring portions 4, and the spring portions 4 are in contact with the rod portion 51 of the male terminal 50 by the fitting force. At the position of the indented portion 4a of the spring portion 4, the spring portion 4 is in contact with the rod portion 51 of the male terminal 50 by the elastic return force of the spring portion 4.

As described above, the spring portion 4 is abutted against the protrusion 6 and is in contact with the rod portion 51 of the male terminal 50 at the portion corresponding to the protrusion 6. Accordingly, since in the spring portion 4 the portion corresponding to the protrusion 6 may not be elastically displaced toward the protrusion 6 (outward), even if an external force due to vibration or the like is applied to the spring portion 4, the spring portion 4 can reliably maintain the contact with the male terminal 50, thus preventing instability of the contact.

The spring portion 4 is a cantilever support extending from the tubular portion 3, and on the free end side as the front end side, the spring portion 4 is in contact with the rod portion 51 of the male terminal 50 by the elastic return force. Accordingly, since the spring portion 4 is in contact with the rod portion 51 of the male terminal 50 at the two portions, the spring portion 4 can be in contact with the rod portion 51 with a large contact area. Since the spring portion 4 is elastically deformed with the position of the protrusion 6 as a spring fulcrum point, the spring portion 4 has a large spring constant as compared with the case where the protrusion 6 is not provided. Accordingly, since the indented portion 4a (the front end side) of the spring portion 4 is less likely to be elastically deformed by an external force such as vibration, non-contact between contact points due to vibration or the like can be prevented.

The tubular portion 3 has a cylindrical shape as viewed from the insertion direction of the male terminal 50, and the rod portion 51 of the male terminal 50 has a columnar shape. Therefore, the rod portion 51 of the male terminal 50 can be fitted in the tubular portion 3 in any directions. Namely, a direction in which the male terminal 50 is fitted into the female terminal 1 is free and is not restricted.

The three spring portions 4 are arranged at equal intervals in the circumferential direction of the tubular portion 3. Accordingly, since the three spring portions 4 are in contact with the rod portion 51 of the male terminal 50 so as to encompass the rod portion 51, the center position of the tubular portion 3 is the insertion position of the rod portion 51 of the male terminal 50, thus obtaining good insertion properties. Since the three spring portions 4 are in contact with the rod portion 51 with equal contact loads, a highly reliable contact state can be attained. The number of the spring portions 4 may be one, two, or four or more.

In this specification, the position of the protrusion 6 of the spring portion 4 where each of the spring portions 4 and the rod portion 51 are in contact with each other (the a region of FIG. 5B) includes a region corresponding to the protrusion 6 and its surrounding region. Namely, when an external force such as vibration is applied to the spring portion 4, this region may not be elastically displaced even by elastic deformation of the spring portion 4.

What is claimed is:

1. A terminal comprising:
a tubular portion including a terminal insertion chamber;
a spring portion which protrudes in the tubular portion and is in contact with a rod portion of a mating terminal inserted into the terminal insertion chamber, while being elastically deformed outward; and
a protrusion which is provided in the tubular portion and protrudes in an elastic deformation region of the spring portion,
wherein the spring portion is abutted against the protrusion and is in contact with the rod portion of the mating terminal at a portion corresponding to the protrusion.

2. The terminal according to claim 1, wherein the spring portion is a cantilever support extending from the tubular portion, and a free end side of a front end of the spring portion is in contact with the rod portion of the mating terminal by the elastic return force.

3. The terminal according to claim 1, wherein the tubular portion has a cylindrical shape, and a plurality of the spring portions is arranged at equal intervals in a circumferential direction of the tubular portion.
